(19) United States
(12) Patent Application Publication
(10) Pub. No.: US 2025/0390239 A1
(43) Pub. Date: Dec. 25, 2025

(54) DATA STORAGE DEVICE AND METHOD OF OPERATING THE SAME

(71) Applicant: SK hynix Inc., Icheon-si (KR)

(72) Inventor: Geu Rim LEE, Icheon-si (KR)

(21) Appl. No.: 19/092,357

(22) Filed: Mar. 27, 2025

(30) Foreign Application Priority Data
Jun. 24, 2024 (KR) 10-2024-0082035

(51) Int. Cl. G06F 3/06

(52) U.S. Cl. CPC G06F 3/064; G06F 3/0604; G06F 3/0679

(57) ABSTRACT

Data storage devices and methods of operating the data storage devices are disclosed. In an embodiment, a data storage device may include a memory device including a plurality of memory blocks allocated to a plurality of zones that are a storage regions corresponding to a plurality of logical address groups provided from a host, and a controller configured to control the memory device to select a victim zone for moving stored data to a target zone, from among zones for which a finish zone request is received from the host, and move data from a memory block allocated to the victim zone to a remaining space of a memory block allocated to the target zone.

### CROSS-REFERENCE TO RELATED APPLICATION

This patent document claims the priority and benefits of Korean patent application number 10-2024-0082035 filed on Jun. 24, 2024, the entire disclosure of which is incorporated herein by reference as part of the disclosure of this patent document.

### TECHNICAL FIELD

Various embodiments of the disclosed technology generally relate to an electronic device, and more particularly to a data storage device and a method of operating the data storage device.

### BACKGROUND

A data storage device is a device that stores data under the control of a host device, such as a computer or a smartphone. The data storage device may include a memory device that stores data and a memory controller that controls the memory device. Memory devices are classified into volatile memory devices and nonvolatile memory devices.

A volatile memory device may be a memory device that stores data only while power is being supplied, and the data is lost when the supply of power is interrupted. Examples of the volatile memory device may include a static random access memory (SRAM) and a dynamic random access memory (DRAM).

The nonvolatile memory device is a memory device that retains data even when the supply of power is interrupted. Examples of the nonvolatile memory device include a read only memory (ROM), a programmable ROM (PROM), an electrically programmable ROM (EPROM), an electrically erasable and programmable ROM (EEPROM), and a flash memory.

### SUMMARY

The disclosed technology can be implemented in some embodiments to provide a data storage device that can efficiently manage storage space and a method of operating the data storage device.

In an embodiment of the disclosed technology, a data storage device may include a memory device including a plurality of memory blocks allocated to a plurality of zones that are storage regions corresponding to a plurality of logical address groups provided from a host, and a controller configured to control the memory device to select a victim zone for moving stored data to a target zone, from among zones for which a finish zone request is received from the host, and move data from a memory block allocated to the victim zone to a remaining space of a memory block allocated to the target zone, wherein the finish zone request is received from the host.

In an embodiment of the disclosed technology, a data storage device may include a memory device including a plurality of first memory blocks allocated to a plurality of zones, and a plurality of second memory blocks that are remaining memory blocks other than the first memory blocks, and a controller configured to control the memory device to perform a garbage collection operation by: storing data from a victim memory block that is selected according to a size of stored valid data from among the second memory blocks, into a remaining storage space of a target memory block selected from among the first memory blocks.

In an embodiment of the disclosed technology, a data storage device may include a memory device including memory blocks, and a controller configured to allocate the memory blocks to a plurality of zones, respectively, and control the memory device to move data from memory blocks respectively allocated to two or more zones in a full state in which a write pointer has an invalid value among the plurality of zones, to a memory block allocated to one zone selected from among the two or more zones in response to a finish zone request received from a host.

In an embodiment of the disclosed technology, a data storage device may include a memory device including memory blocks respectively allocated to a plurality of zones that are storage regions respectively corresponding to logical address groups provided from a host, and a controller configured to control the memory device to store data, present in a memory block allocated to a victim zone, selected from among zones for which a finish zone request is received from the host among the plurality of zones, in remaining space of a memory block allocated to a target zone selected from among the zones for which the finish zone request is received.

In an embodiment of the disclosed technology, a data storage device may include a memory device including first memory blocks respectively allocated to a plurality of zones, and second memory blocks that are remaining memory blocks other than the first memory blocks, and a controller configured to control the memory device to perform a garbage collection operation of storing data, stored in a victim memory block selected according to a size of stored valid data from among the second memory blocks, in remaining storage space of a target memory block selected from among the first memory blocks.

In an embodiment of the disclosed technology, a data storage device may include a memory device including memory blocks, and a controller configured to allocate the memory blocks to a plurality of zones, respectively, and control the memory device to move data, stored in memory blocks respectively allocated to two or more zones in a full state in which a write pointer has an invalid value among the plurality of zones, to a memory block allocated to one zone selected from among the two or more zones in response to a finish zone command received from a host.

### BRIEF DESCRIPTION OF THE DRAWINGS

FIG. 1 is a diagram illustrating an example of a data storage device based on some embodiments of the disclosed technology.

FIG. 2 is a diagram illustrating an example of a memory device of FIG. 1.

FIG. 3 is a diagram illustrating an example structure of a memory block of a plurality of memory blocks of FIG. 2.

FIG. 4 is a diagram illustrating an example that manages the storage space of a data storage device based on some embodiments of the disclosed technology.

FIG. 5 is a diagram illustrating an example that manages the storage space of a data storage device based on some embodiments of the disclosed technology.

FIG. 6 is a diagram for explaining the states of a zone based on some embodiments of the disclosed technology.

FIG. 7 is a diagram illustrating an example process of storing data in a zone.

FIG. 8 is a diagram illustrating an example of a controller of FIG. 1.

FIG. 9 is a diagram illustrating an example of zone status information of FIG. 8.

FIG. 10 is a diagram illustrating an example of zone fragmentation information of FIG. 8.

FIG. 11 is a diagram illustrating an example of zone mapping information of FIG. 8.

FIGS. 12 to 14 are diagrams for explaining an example operation of a data storage device based on some embodiments of the disclosed technology.

FIGS. 15 and 16 are diagrams for explaining an example operation of a data storage device based on some embodiments of the disclosed technology.

FIG. 17 is a flowchart illustrating an example operation of a data storage device based on some embodiments of the disclosed technology.

FIG. 18 is a flowchart illustrating an example operation of a data storage device based on some embodiments of the disclosed technology.

FIG. 19 is a diagram illustrating an example of the controller of FIG. 1.

FIG. 20 is a block diagram illustrating a user system based on some embodiments of the disclosed technology.

### DETAILED DESCRIPTION

Specific structural or functional descriptions of the embodiments of the disclosed technology disclosed in this patent document are provided as examples of the disclosed technology. The embodiments of the disclosed technology may be implemented in various forms, and should not be construed as being limited to the embodiments described in this patent document.

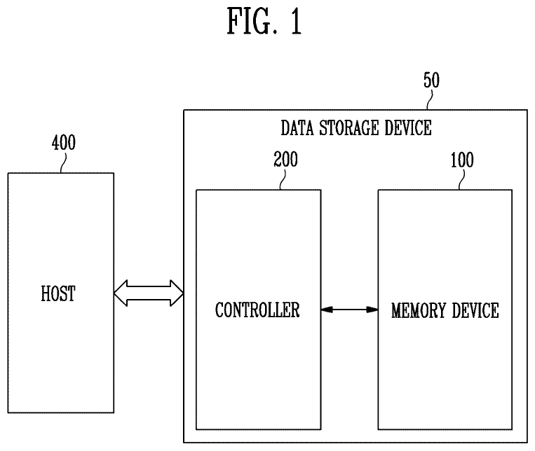

FIG. 1 is a diagram illustrating an example of a data storage device based on some embodiments of the disclosed technology.

Referring to FIG. 1, a data storage device 50 may include a memory device 100 and a controller 200. The data storage device 50 may be a device that stores data under the control of a host 400, such as a mobile phone, a smartphone, a laptop computer, a desktop computer, a game console, a smart television (TV), a tablet PC, or an in-vehicle infotainment system. In an embodiment, the data storage device 50 may be a device such as a server or a data center, controlled by the host 400, through wired/wireless communication for storing data at a remote place.

The data storage device 50 may interface with the host 400 through various communication methods, and may be implemented as various devices depending on the interfacing methods. For example, the data storage device 50 may be implemented as any one of various types of storage devices, such as a solid state drive (SSD), an embedded multimedia card (eMMC), a SD, mini-SD, or micro-SD-type secure digital card, a universal serial bus (USB) storage device, a universal flash storage (UFS) device, a personal computer memory card international association (PCMCIA) card-type storage device, a peripheral component interconnection (PCI) card-type storage device, a PCI express (PCI-E) card-type storage device, a compact flash (CF) card, and a smart media card. In some implementations, the data storage device 50 may be a data storage device implemented based on zoned storage principles, such as a Zoned Universal Flash Storage (ZUFS), which improves efficiency of data management. For example, the ZUFS can optimize data transfer between an operating system and storage devices by storing data with similar characteristics in the same zone of the Universal Flash Storage (UFS).

In an embodiment, the data storage device 50 may be manufactured in any one of various types of package forms. For example, the data storage device 50 may be manufactured in any one of various types of package forms, such as package on package (POP), system in package (SIP), system on chip (SOC), multi-chip package (MCP), chip on board (COB), wafer-level fabricated package (WFP), and wafer-level stack package (WSP).

The memory device 100 may store data. The memory device 100 may be operated in response to the control of the controller 200. The memory device 100 may include a plurality of memory cells that stores data. Each of the memory cells may store one data bit or a plurality of data bits.

The memory cells may be accessed in preset unit sizes depending on the type of memory device. The unit sizes in which memory cells are accessed may vary depending on the operations. For example, the memory cells may be accessed in different unit sizes for a write operation (or program operation) that stores data in each memory cell, a read operation that senses the voltage or current that indicates data stored in each memory cell, and an erase operation that deletes data stored in each memory cell.

In an embodiment, the memory device 100 may be a double data rate synchronous dynamic random access memory (DDR SDRAM), a low power double data rate fourth generation (LPDDR4) SDRAM, a graphics double data rate (GDDR) SDRAM, a low power DDR (LPDDR) SDRAM, a Rambus DRAM (RDRAM), a NAND flash memory, a vertical NAND flash memory, a NOR flash memory, a resistive RAM (RRAM), a phase-change memory (PCM), a magnetoresistive RAM (MRAM), a ferroelectric RAM (FRAM), or a spin transfer torque RAM (STT-RAM).

The memory device 100 may receive a command and an address from the controller 200, and may access the area of the memory cell array, selected by the address. The memory device 100 may perform an operation indicated by the command on the area selected by the address. For example, the memory device 100 may perform a write operation (program operation), a read operation, and an erase operation. During a program operation, the memory device 100 may write data to the area selected by the address. During a read operation, the memory device 100 may read data from the area selected by the address. During an erase operation, the memory device 100 may erase data stored in the area selected by the address.

The controller 200 may control the overall operation of the data storage device 50.

When power is applied to the data storage device 50, the controller 200 may run firmware (FW). The data storage device 50 may translate a logical block address (LBA), provided by the host 400, into a physical address (i.e., physical block address (PBA)) used by the memory device 100. The logical block address (LBA) may be an address for identifying data provided by the host. The physical address (PBA) may be an address indicating a position at which data is stored in the memory device 100. In some embodiments, the logical block address (LBA) may have the same meaning as a logical address, and the physical block address (PBA) may have the same meaning as the physical address.

The controller 200 may control the memory device 100 to perform a write operation, a read operation or an erase operation in response to a request received from the host 400. During the write operation, the controller 200 may provide a write command (program command), an address, and data to the memory device 100. During the read operation, the controller 200 may provide a read command and an address to the memory device 100. During the erase operation, the controller 200 may provide an erase command and an address to the memory device 100.

The memory device 100 included in the data storage device 50 may be managed as a plurality of zones. The plurality of zones may be areas managed under the control of the host 400. In some implementations, the data storage device 50 can optimize storage efficiency by dividing the data storage space in the data storage device 50 into zones such as empty zones, open zones, closed zones, and full zones. For example, empty zones refer to zones that are unwritten and ready to be written to, open zones refer to zones that are actively being written to, closed zones are zones that are written but not full and are no longer accepting new writes, and full zones refer to zones that are completely filled with data and no further writes are possible. The host 400 may control the data storage device 50 so that data of the same type and data generated by the same cause are stored in the same zone.

In some implementations, the host 400 may store data in the data storage device 50 or request the data stored in the data storage device 50 according to a logical address. The logical addresses used by the host 400 may be logical addresses within a preset range. The host 400 may manage the logical addresses by dividing them into a plurality of address groups, ensuring that data corresponding to each address group is included in a single, identical zone. That is, the plurality of zones may be managed to store data in their respective address groups.

In an embodiment, the controller 200 may control the memory device 100 to perform various background operations so that the data in the data storage device 50 is efficiently managed. For example, the controller 200 may control the memory device 100 to perform a garbage collection operation in order to secure the number of free blocks in which data is not stored among the memory blocks included in the memory device 100.

In an embodiment, the controller 200 may include an error correction code (ECC) processor (not illustrated). Alternatively, the ECC processor, separate from the controller 200, may be included in the data storage device 50 as a separate chip or device. The ECC processor (not illustrated) may detect and correct errors contained in data obtained from a memory die included in the memory device 100 through a read operation. In an embodiment, the number of bits that can be corrected by the ECC processor may be limited.

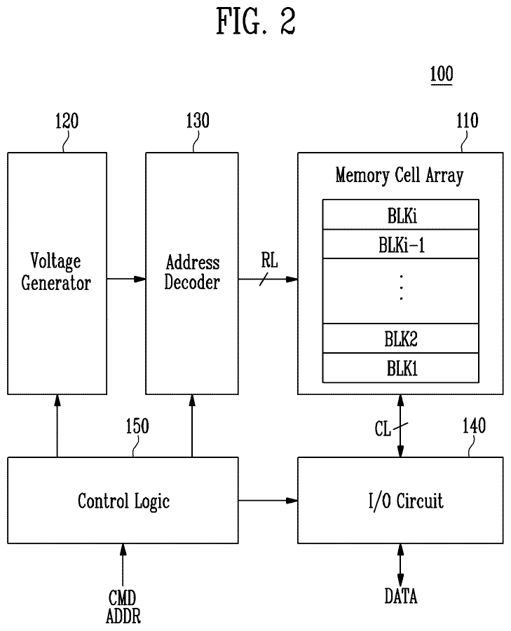

FIG. 2 is a diagram illustrating an example of a memory device of FIG. 1.

Referring to FIG. 2, the memory device 100 may include a memory cell array 110, a voltage generator 120, an address decoder 130, an input/output (I/O) circuit 140, and a control logic 150.

The memory cell array 110 may include a plurality of memory blocks BLK1 to BLKi. The plurality of memory blocks BLK1 to BLKi are connected to the address decoder 130 through row lines RL. The plurality of memory blocks BLK1 to BLKi may be connected to the input/output circuit 140 through column lines CL. In an embodiment, the row lines RL may include word lines, source select lines, and drain select lines. In an embodiment, the column lines CL may include bit lines.

Each of the memory blocks BLK1 to BLKi may include a plurality of memory cells. In an embodiment, the plurality of memory cells may be nonvolatile memory cells. Memory cells connected to the same word line, among the plurality of memory cells, may be defined as one page. For example, each of the memory blocks BLK1 to BLKi may include a plurality of pages.

Each of the memory cells included in the memory cell array 110 may be implemented as a single-level cell (SLC) capable of storing one data bit, a multi-level cell (MLC) capable of storing two data bits, a triple-level cell (TLC) capable of storing three data bits, or a quad-level cell (QLC) capable of storing four data bits.

In an embodiment, the plurality of memory blocks BLK1 to BLKi may be respectively allocated to a plurality of zones managed by the host 400, described above with reference to FIG. 1. In an embodiment, at least some of the plurality of memory blocks BLK1 to BLKi may include a zoned region that is allocated to the plurality of zones and a non-zone-based region that is not managed by the plurality of zones.

In an embodiment, the voltage generator 120, the address decoder 130, and the input/output circuit 140 may be collectively referred to as a peripheral circuit. The peripheral circuit may drive the memory cell array 110 under the control of the control logic 150. For example, the peripheral circuit may activate the memory cell array 110 to perform a write operation (program operation), a read operation, and an erase operation.

The voltage generator 120 may generate a plurality of operating voltages using an external supply voltage provided to the memory device 100. The voltage generator 120 may be operated under the control of the control logic 150. In an embodiment, the voltage generator 120 may generate an internal supply voltage by regulating the external supply voltage. The internal supply voltage generated by the voltage generator 120 may be used as an operating voltage for the memory device 100.

In an embodiment, the voltage generator 120 may generate a plurality of operating voltages using the external supply voltage or the internal supply voltage. The voltage generator 120 may generate various voltages required by the memory device 100. For example, the voltage generator 120 may generate a plurality of erase voltages, a plurality of program voltages, a plurality of pass voltages, a plurality of select read voltages, and a plurality of unselect read voltages.

The voltage generator 150 may include a plurality of pumping capacitors for receiving an internal supply voltage to generate a plurality of operating voltages having various voltage levels, and may generate a plurality of operating voltages by selectively enabling the plurality of pumping capacitors under the control of the control logic 150.

The plurality of generated operating voltages may be supplied to the memory cell array 110 by the address decoder 130.

The address decoder 130 is connected to the memory cell array 110 through the row lines RL. The address decoder 130 may be operated in response to control of the control logic 150. The address decoder 130 may receive addresses ADDR from the control logic 150. The address decoder 130 may decode a block address among the received addresses ADDR. The address decoder 130 may select at least one of the memory blocks BLK1 to BLKi according to the decoded block address. The address decoder 130 may decode a row address among the received addresses ADDR. The address decoder 130 may select at least one of word lines of the selected memory block according to the decoded row address. In an embodiment, the address decoder 130 may decode a column address among the received addresses ADDR. The address decoder 130 may connect the input/output circuit 140 to the memory cell array 110 according to the decoded column address.

In an embodiment, the address decoder 130 may include components, such as a row decoder, a column decoder, and an address buffer.

The input/output circuit 140 may include a plurality of page buffers (not illustrated). The plurality of page buffers may be connected to the memory cell array 110 through the bit lines. During a write operation (program operation), data may be stored in the selected memory cells depending on the data stored in the plurality of page buffers. During a read operation, data stored in the selected memory cells may be sensed through the bit lines, and the sensed data may be stored in the page buffers.

The control logic 150 may control the address decoder 130, the voltage generator 120, and the input/output circuit 140. The control logic 150 may be operated in response to a command CMD transmitted from an external device. The control logic 150 may control the peripheral circuit by generating control signals in response to the command CMD and the addresses ADDR.

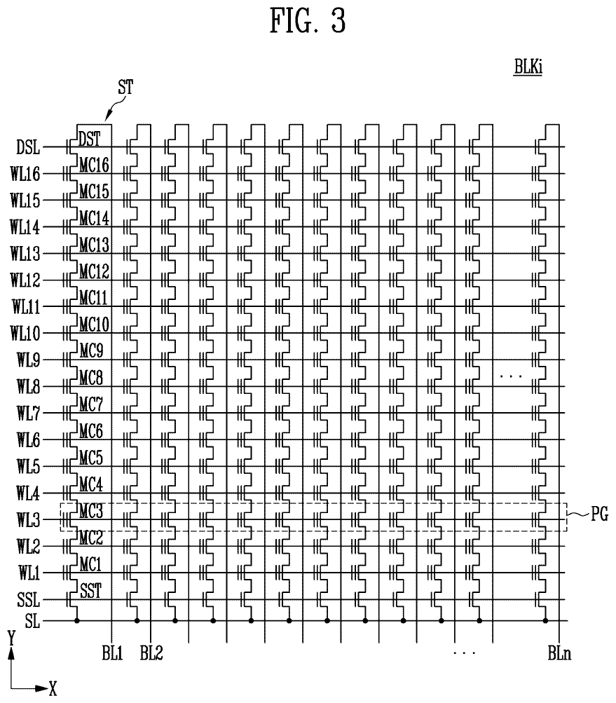

FIG. 3 is a diagram illustrating an example structure of a memory block of a plurality of memory blocks of FIG. 2.

The memory block BLKi may indicate any one memory block BLKi among the memory blocks BLK1 to BLKi of FIG. 2.

Referring to FIG. 3, memory cells may be connected to a plurality of word lines arranged between a first select line and a second select line. Here, the first select line may be a source select line SSL, and the second select line may be a drain select line DSL. In detail, the memory block BLKi may include a plurality of strings ST connected between bit lines BL1 to BLn and a source line SL. The bit lines BL1 to BLn may be connected to the strings ST, respectively, and the source line SL may be connected in common to the strings ST. Since the strings ST may be equally configured, a string ST connected to the first bit line BL1 will be described in detail by way of example.

The string ST may include a source select transistor SST, a plurality of memory cells MC1 to MC16, and a drain select transistor DST which are connected in series to each other between the source line SL and the first bit line BL1. A single string ST may include at least one source select transistor SST and at least one drain select transistor DST, and more memory cells than the memory cells MC1 to MC16 illustrated in the drawing may be included in the string ST.

A source of the source select transistor SST may be connected to the source line SL, and a drain of the drain select transistor DST may be connected to the first bit line BL1. The memory cells MC1 to MC16 may be connected in series between the source select transistor SST and the drain select transistor DST. Gates of the source select transistors SST included in different strings ST may be connected to the source select line SSL, gates of the drain select transistors DST included in different strings ST may be connected to the drain select line DSL, and gates of the memory cells MC1 to MC16 may be connected to a plurality of word lines WL1 to WL16, respectively. A group of memory cells connected to the same word line, among the memory cells included in different strings ST, may be a page (PG). Therefore, the memory block BLKi may include a number of pages (PG) identical to the number of word lines WL1 to WL16.

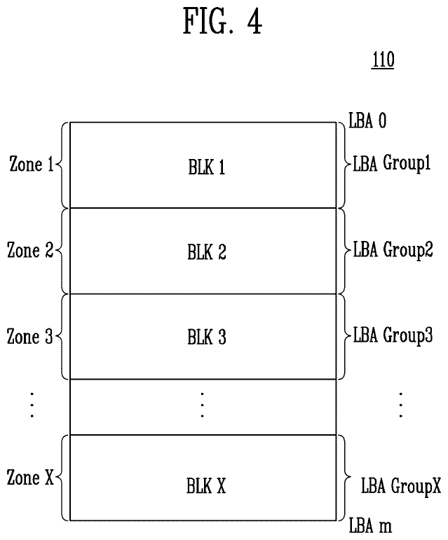

FIG. 4 is a diagram illustrating an example that manages the storage space of a data storage device based on some embodiments of the disclosed technology.

Referring to FIGS. 1, 2, and 4, the host 400 may manage the storage space of the data storage device 50 as a plurality of zones. For example, the host 400 may manage the storage space of the data storage device 50 by dividing the storage space into first to X-th zones Zone 1 to Zone X.

As shown in FIG. 4, in some implementations, a logical address provided by the host 400 may be selected from among a 0-th logical address LBA 0 to an m-th logical address LBA m that are divided (or grouped) into a plurality of logical address groups. For example, the 0-th logical address to the m-th logical address LBA 0 to LBA m may be grouped into first to X-th logical address groups LBA Group 1 to LBA Group X. The numbers of logical addresses included in respective logical address groups may be identical to each other.

The logical addresses to be provided by the host 400 may be divided into a plurality of logical address groups. The first to X-th zones Zone 1 to Zone X may correspond to the plurality of logical address groups, respectively. That is, the first zone Zone 1 may correspond to the first logical address group LBA Group 1, the second zone Zone 2 may correspond to the second logical address group LBA Group2, and the third zone Zone 3 may correspond to the third logical address group LBA Group3. In this way, the X-th zone Zone X may correspond to the X-th logical address group LBA GroupX. In an implementation where a zone corresponds to a logical address group, data identified by logical addresses included in the logical address group may be managed under the corresponding zone ID.

In FIG. 4, the memory blocks included in the memory cell array 110 may correspond one-to-one to the plurality of zones, respectively. That is, the plurality of zones may correspond to the memory blocks, respectively, in a block mapping manner. That is, the controller 200 may control the memory device 100 such that, when one zone is open, one memory block among the memory blocks is mapped to the corresponding zone and then data identified by logical addresses included in the logical address group belonging to the corresponding zone is stored in an allocated memory block.

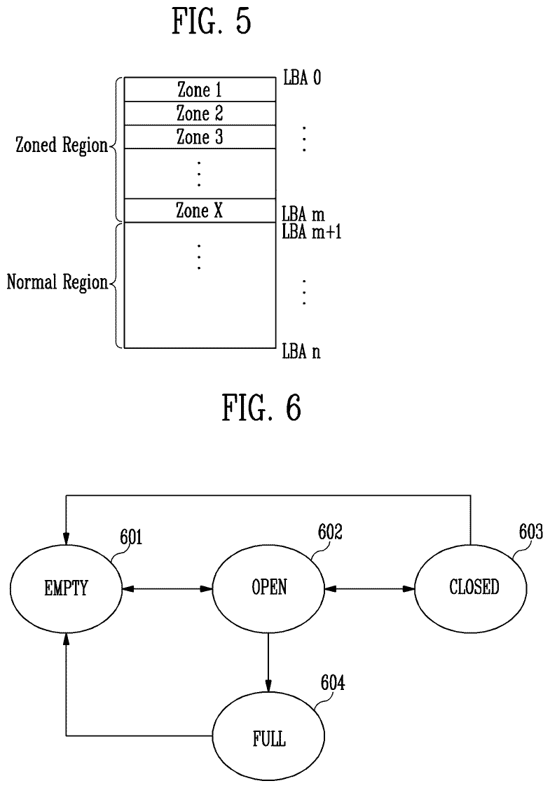

FIG. 5 is a diagram illustrating an example that manages the storage space of a data storage device based on some embodiments of the disclosed technology.

Referring to FIGS. 1, 2, and 5, the host 400 may request the controller 200 to store data identified by a 0-th logical address LBA 0 to an n-th logical address LBA n in the memory device 100 included in the data storage device 50.

In FIG. 4, all data provided by the host 400 is managed on a zone basis. However, in FIG. 5, some data is managed on a zone basis, while the remaining data is managed in a non-zone-based manner.

Referring to FIG. 5, the storage area of the memory device 100 included in the data storage device 50 may be divided into a zoned region managed on a zone basis and a non-zone-based region that is not managed on a zone basis. Data corresponding to (or identified by) the 0-th to m-th logical addresses LBA 0 to LBA m, among the 0-th logical address LBA 0 to the n-th logical address LBA n, may be managed by first to X-th zones Zone 1 to Zone X. Data identified by the m+1-th logical address to the n-th logical address LBA m+1 to LBA n may be managed based on units other than zones.

In some implementations, data managed in the zoned region may be managed using the method described with reference to FIG. 4. Data managed in the non-zone-based region may be stored and managed in the memory device 100 using various mapping methods such as page mapping or block mapping. In various embodiments, the controller 200 may allocate a super block including a plurality of memory blocks as the space for storing data of the logical addresses in the non-zone-based region.

In some implementations, since the zoned region is directly managed by the host 400, the controller 200 does not arbitrarily perform garbage collection operations on the zoned region. However, since the non-zone-based region is directly managed by the controller 200, the controller 200 may perform garbage collection operations to relocate the stored data to secure additional free blocks when the number of free blocks is insufficient.

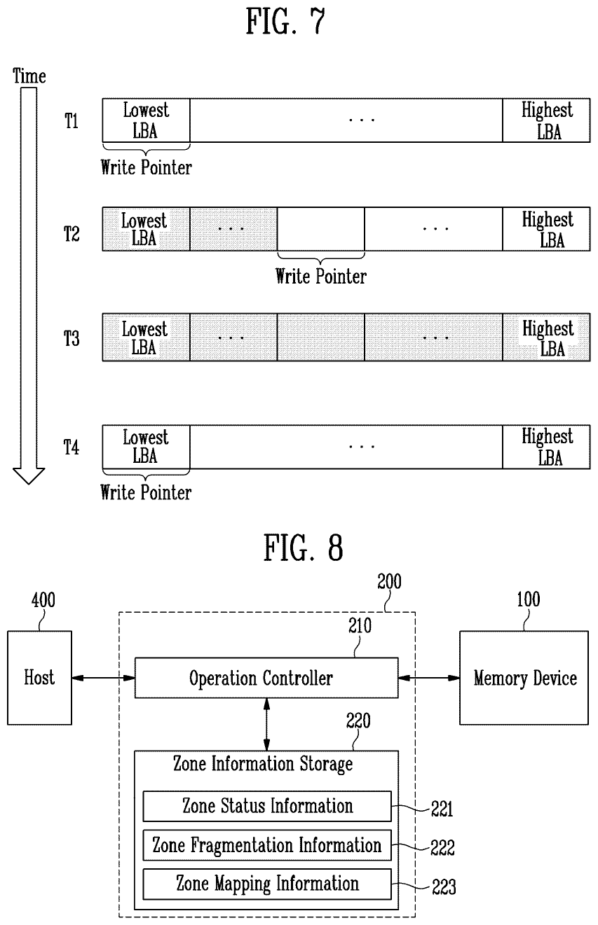

FIG. 6 is a diagram illustrating the states of a zone based on some embodiments of the disclosed technology.

Referring to FIGS. 1 and 6, the states of each zone may include an empty state 601, an open state 602, a closed state 603, and a full state 604. In some implementations, the empty state 601 indicates that the corresponding zone is an empty zone, the open state 602 indicates that the corresponding zone is an open zone, the closed state 603 indicates that the corresponding zone is a closed zone, and the full state 604 indicates that the corresponding zone is a full zone.

The states of the zone may be changed through the processing of requests related to the corresponding zone provided by the host 400. Requests related to the zone that can be provided by the host 400 are shown in Table 1 below.

TABLE 1

| | State of zone after request is |
|---|---|
| Request type | processed |
| CLOSE ZONE REQUEST | CLOSED |
| FINISH ZONE REQUEST | FULL |
| OPEN ZONE REQUEST | OPEN OR EMPTY |
| REPORT ZONE REQUEST | — |
| RESET WRITE POINTER REQUEST | EMPTY |

The close zone request (CLOSE ZONE) may be a request or command that is provided by the host 400 when a write or read request for the corresponding zone is not provided, e.g., for a predetermined period of time. When the close zone request (CLOSE ZONE) is received, the controller 200 may change the state of the requested zone to the closed state 603. The finish zone request (FINISH ZONE) may be a request or command that is provided by the host 400 when an additional write request is not provided until the corresponding zone is initialized. When the finish zone request is received, the controller 200 may change the state of the requested zone to the full state 604.

The open zone request (OPEN ZONE) may be a request or command that is provided by the host 400 to use the corresponding zone, e.g., before a write request or a read request for the corresponding zone is provided. When the open zone request is received, the controller 200 may change the state of the requested zone to the empty state 601 or the open state 602.

The report zone request (REPORT ZONE) may be a request or command that requests the host 400 to provide information about a zone, such as the number of zones in use, the ID of a zone, and the state of a zone.

The reset write pointer request (RESET WRITE POINTER) may be a request or command that instructs the write pointer of a zone to be initialized. When the write pointer of the zone is initialized, the write pointer of the corresponding zone may indicate the lowest logical address among logical addresses belonging to the zone. In some implementations, the term “write pointer” may refer to the location where data is written. In an implementation where a memory controller locates an empty space in a data storage device and writes data there, the memory controller can locate the next location where the write operation will occur using the write pointer.

The empty state 601 may be a state before data is stored in the logical addresses belonging to the corresponding zone. That is, when the zone is in the empty state 601, the corresponding zone is in an empty state in which data is not present. When the reset write pointer request (RESET WRITE POINTER) provided by the host 400 is received, the controller 200 may initialize the write pointer of a requested zone. The initialization of the write pointer may indicate that the logical address where data will be stored in the corresponding zone is the lowest logical address among logical addresses belonging to the corresponding zone. When the write request for the zone in the empty state 601 is processed, the state of the zone may be changed to the open state 602.

The open state 602 may be a state in which data is being stored or can be stored in the logical addresses belonging to the corresponding zone. That is, the open state 602 may be a state in which the host 400 can issue a write request to store data in the zone or a read request to retrieve data stored in the zone. The zone in the open state 602 may be changed to the closed state 603 in response to a close zone request provided by the host 400. Alternatively, the state of the zone in the open state 602 may be changed to the full state 604 after data corresponding to all logical addresses included in the zone are stored. In an embodiment, the zone in the open state 602 may be changed to the full state 604 in response to a finish zone request provided by the host 400.

The closed state 603 may be a state in which the host 400 is temporarily not using the corresponding zone. In response to an open zone request provided by the host 400, the controller 200 may change the state of the zone from the closed state 603 to the open state 602. Alternatively, in response to a reset write pointer request provided by the host 400, the controller 200 may change the state of the zone from the closed state 603 to the open state 602.

The full state 604 may be a state in which there are no longer any available logical addresses for storing data in the corresponding zone. In some embodiments, the write pointer of the zone in the full state 604 may have an invalid value. In some embodiments, the zone in the full state 604 may be changed to the empty state 601 in response to the reset write pointer request, but cannot transition directly to the open state 602. Therefore, when there is remaining space in a memory block allocated to the zone in the full state 604, that space cannot be used to store data in response to the write request provided by the host 400.

Although, in FIG. 6, the state of the zone has been described as being the empty state 601, the open state 602, the closed state 603, and the full state 604, the state may further include a read only state, an inactive state, and an offline state. In various embodiments, the open state 602 may be divided into an implicit open state and an explicit open state.

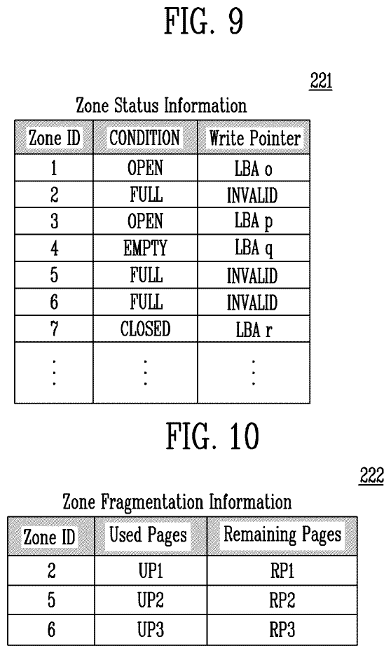

FIG. 7 is a diagram illustrating an example process of storing data in a zone.

Referring to FIGS. 6 and 7, the zone may be managed using a write pointer. In some implementations, data may be stored in a memory block allocated to the zone. In an embodiment, data may be stored in the memory block allocated to the zone in the order of logical addresses included in the zone.

The write pointer of the zone may indicate the logical address of data to be stored in the future. When data is stored in the memory block allocated to the zone, the write pointer of the zone may be changed to indicate the logical address of data to be subsequently stored.

The zone may correspond to a plurality of logical addresses. The logical addresses corresponding to the zone may be logical addresses within a certain range. Therefore, the logical addresses corresponding to the zone may include logical addresses ranging from the lowest logical address to the highest logical address.

At time T1, the zone may be opened in response to an open zone request from the host 400. When the zone is opened for the first time, the state of the zone may be an empty state. The write pointer of the zone in the empty state may be set to the lowest logical address (LBA).

At time T2, when data is stored in the zone, the write pointer of the zone may point to the logical address where the next data will be stored. At time T2, shaded regions may indicate logical addresses where data has been stored, and the remaining regions may indicate logical addresses where data has not yet been stored. At time T2, the state of the zone may be open state.

At time T3, data corresponding to all logical addresses included in the zone may be stored. In this case, the state of the zone may be changed to a full state, and the write pointer of the zone may have an invalid value.

At time T4, the write pointer of the zone points to the lowest logical address (LBA) again in response to a reset write pointer request from the host 400, and the state of the zone may be changed to an empty state.

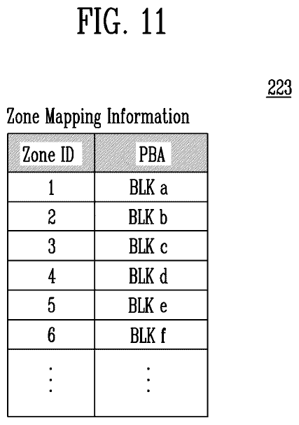

FIG. 8 is a diagram illustrating an example of the controller of FIG. 1.

Referring to FIG. 8, the controller 200 may include an operation controller 210 and a zone information storage 220. The zone information storage 220 may store information related to zones. The information stored in the zone information storage 220 may include zone status information 221, zone fragmentation information 222, and zone mapping information 223.

The zone status information 221 may include the states of zones and the write pointers of respective zones.

The zone fragmentation information 222 may include information about the number of used pages and the number of remaining pages of each memory block allocated to the corresponding zone.

The zone mapping information 223 may include the physical address of a memory block allocated to each zone.

The operation controller 210 may control the operation of the controller 200 in response to a request from the host 400.

The operation controller 210 may receive requests related to the zones from the host 400, and may process the requests related to the zones. In some implementations, when an open zone request is received from the host 400, the operation controller 210 may allocate a memory block to a zone requested to be opened. The operation controller 210 may update the zone status information in response to the open zone request. The operation controller 210 may change the state of the zone requested to be opened to an empty state, and may change the write pointer to the lowest logical address of the zone requested to be opened.

The operation controller 210 may receive a close zone request from the host 400. The operation controller 210 may update the zone status information 221 so that the state of the zone requested to be closed is changed from an open state to a closed state. The write pointer of the zone changed to the closed state may be maintained at the write pointer when the close zone request has been received. Thereafter, when the state of the zone is changed again to an open state, data may be stored from the position indicated by the stored write pointer.

The operation controller 210 may receive a reset write pointer request from the host 400. The operation controller 210 may reset the write pointer of a zone requested to reset the write pointer. In this case, the write pointer of the zone may be changed to indicate the lowest logical address among logical addresses corresponding to the zone. The operation controller 210 may update the zone status information 221 so that the state of the zone requested to reset the write pointer is changed to an empty state.

The operation controller 210 may receive a finish zone request from the host 400. The operation controller 210 may update the zone status information 221 so that the write pointer of a zone requested to finish the zone is changed to an invalid value and the state of the zone is changed to a full state. When the state of the zone is changed to the full state, data cannot be stored any more in the corresponding zone until the write pointer of the zone is initialized and then the state of the zone is changed to the empty state. In the case where the remaining pages in which data is not stored are present in the memory block allocated to the zone when the finish zone request is received, the remaining pages cannot be used as the storage space of the zone requested to finish the zone.

In some implementations, although a zone in a full state may be in a state in which data are stored at all logical addresses of the zone, remaining space may occur in a memory block allocated to the zone having changed to the full state in response to the finish zone request, as described above. When a plurality of zones have changed to a full state in response to a finish zone request, a plurality of memory blocks including the remaining space may occur, thus resulting in fragmentation of the storage space.

Therefore, in an embodiment of the disclosed technology, there is provided a method of managing storage space using the fact that data corresponding to logical addresses belonging to a zone having changed to a full state cannot be stored any more in the zone.

In some implementations, the data storage device 50 may perform a zone merge operation of merging data in zones in a full state using the remaining space in allocated memory blocks among the zones in the full state. Hereinafter, the zone merge operation will be described.

In an embodiment, the operation controller 210 may perform the zone merge operation when processing a finish zone request. The operation controller 210 may select a zone, having the smallest number of used pages (i.e., having the largest number of residual pages) among memory blocks allocated to the zones in the full state, as a victim zone based on the zone fragmentation information 222 after processing the finish zone request. In some implementations, the term “victim zone” may be used to indicate the zone from which data is selected to be moved or garbage collected when data storage space needs to be reclaimed.

The operation controller 210 may determine a target zone having a number of remaining pages (e.g., remaining free or empty pages) equal to or greater than the number of used pages of the memory block allocated to the victim zone based on the zone fragmentation information 222. In some implementations, the term “target zone” may be used to indicate the zone where new or relocated data is written.

Thereafter, the operation controller 210 may control the memory device 100 to store or move the data from the used pages of the memory block allocated to the victim zone, into the remaining pages of the memory block allocated to the target zone.

The operation controller 210 may update the zone mapping information 223 so that, after the data is stored or moved from the used pages of the memory block allocated to the victim zone, into the remaining pages of the memory block allocated to the target zone, a physical address corresponding to the victim zone is updated to the physical address of the memory block allocated to the target zone. When the zone merge operation is performed, the result of allocating one memory block to two or more zones may be obtained.

Because data in the victim zone and the target zone is stored in the same memory block, the operation controller 210 cannot erase data stored in the allocated memory block or cannot deallocate the memory block even if a reset write pointer request is received for any one of the victim zone or the target zone. That is, operation controller 210 may discard the data stored in the allocated memory block only when a reset write pointer request both for the victim zone and for the target zone is received.

In an embodiment, the operation controller 210 may select two or more victim zones, and may store data, stored in used pages of memory blocks respectively allocated to the two or more victim zones, in the remaining pages of a memory block allocated to one target zone. In this case, the result of allocating one memory block to three zones may be obtained.

In an embodiment, the operation controller 210 may perform the zone merge operation at preset periods regardless of processing of a finish zone request.

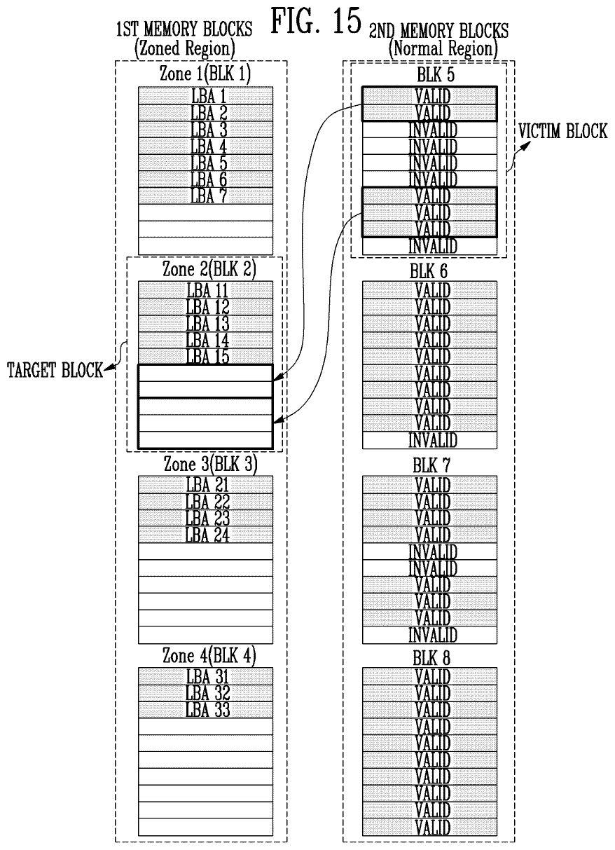

The zone merge operation allowing the controller 200 to store data present in two or more zones in the full state in one memory block will be described in detail later with reference to FIGS. 12 to 14.

In an embodiment of the disclosed technology, the operation controller 210 may control a garbage collection operation.

As described above with reference to FIG. 5, in some embodiments, not all logical addresses provided by the host are managed on a zone basis, and only some logical addresses may be managed on a zone basis. In this case, the operation controller 210 may control the memory device 100 to perform a garbage collection operation to manage the non-zone-based region.

The garbage collection operation may be a background operation performed when the number of free blocks that are empty memory blocks in which data is not present in the memory device 100, is less than the certain number of free blocks. A typical garbage collection operation may select, as victim blocks, two or more memory blocks having the smallest number of valid pages with valid data stored, among memory blocks allocated to the non-zone-based region, and may move the valid data from the victim blocks to one memory block, thus converting the victim blocks back into free blocks.

The garbage collection operation of the data storage device 50 based on an embodiment of the disclosed technology may be performed in a manner in which memory blocks in the non-zone-based region and the zoned region are combined into one memory block.

Referring to FIGS. 1, 2, and 8, the memory device 100 may include first memory blocks allocated to the zoned region and second memory blocks allocated to the non-zone-based region.

When the number of free blocks included in the memory device 100 becomes less than the preset reference number of free blocks, the operation controller 210 may control the memory device 100 to perform a garbage collection operation. In various embodiments, the operation controller 210 may also perform a garbage collection operation in response to a garbage collection request indicated by the host 400 regardless of the number of free blocks included in the memory device 100.

The operation controller 210 may determine a memory block in which the least amount of valid data is stored among the second memory blocks to be a victim block. For example, the operation controller 210 may determine a memory block with the smallest number of valid pages (pages with valid data), among the second memory blocks, to be a victim block. Although not illustrated in FIG. 8, the controller 200 may further include a mapping information storage (not illustrated) in which mapping information of the second memory blocks is stored. The mapping information of the second memory blocks may include information about the logical address and physical address of data stored in the second memory blocks and the number of valid pages.

The operation controller 210 may determine a zone that includes a number of remaining pages equal to or greater than the number of valid pages included in the victim block, to be a target zone based on zone fragmentation information 222, and may determine a memory block allocated to the target zone among the first memory blocks to be a target block.

The operation controller 210 may control the memory device 100 to store the valid data, stored in the victim block, in the remaining pages of the target block.

In an embodiment, valid data in two or more victim blocks may be stored in the remaining pages of the memory block allocated to the target zone.

The operation controller 210 may update the zone fragmentation information 222 of the zone to which the target block is allocated after the garbage collection operation is performed.

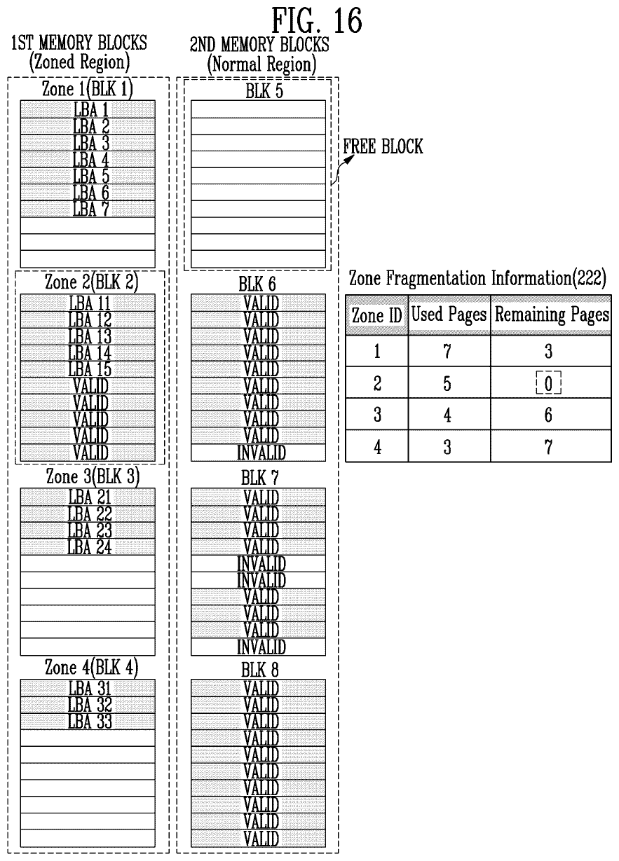

A garbage collection operation in which the controller 200 stores the valid data in the victim block in the remaining pages of the memory block allocated to the zone will be described in detail later with reference to FIGS. 15 and 16.

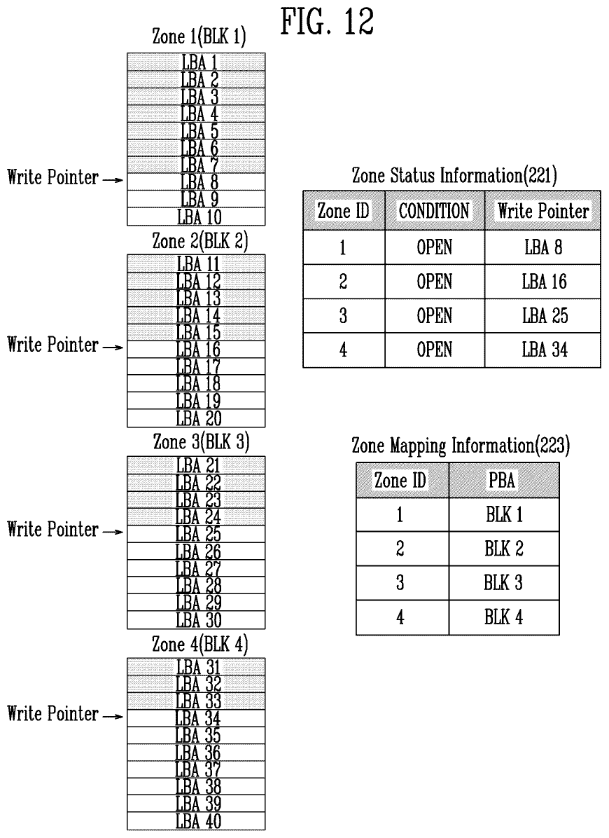

FIG. 9 is a diagram illustrating an example of zone status information of FIG. 8.

Referring to FIGS. 8 and 9, the zone status information may include a zone ID, a zone state, and a write pointer.

The zone ID may be information for identifying each zone. The host 400 may provide the zone ID to indicate which one of zones is related to a request when providing the request for the corresponding zone.

The zone state may indicate the state of each zone. For example, the zone state may be any one of an empty state, an open state, a closed state, and a full state. According to the zone status information of FIG. 9, a first zone and a third zone indicate the open state, a fourth zone indicates the empty state, second, fifth, and sixth zones indicate the full state, and a seventh zone indicates the closed state.

The write pointer of each of the second zone, the fifth zone, and the sixth zone in the full state may indicate an invalid value (INVALID).

The write pointer of each of the remaining zones, that is, the first zone, the third zone, the fourth zone, and the seventh zone may indicate the next logical address at which data is to be stored among logical addresses included in the corresponding zone.

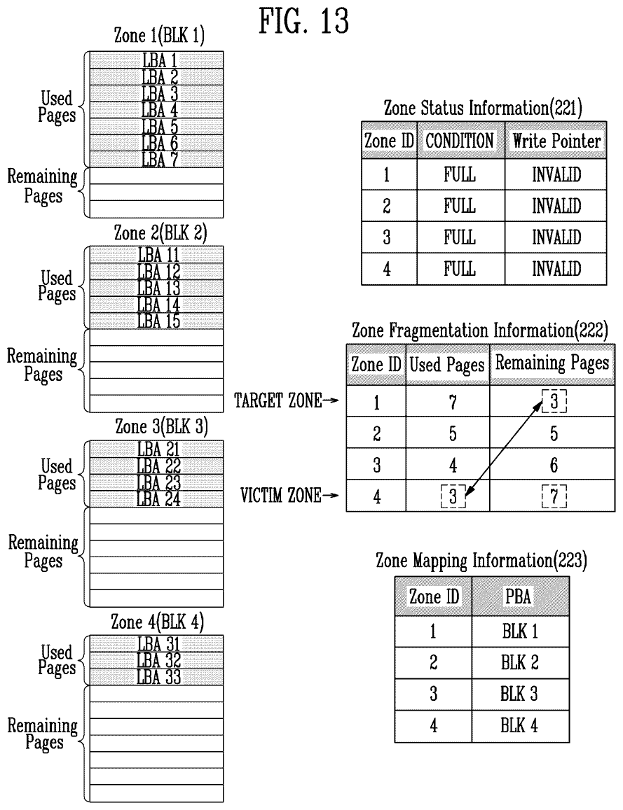

FIG. 10 is a diagram illustrating an example of zone fragmentation information of FIG. 8.

Referring to FIGS. 9 and 10, the zone fragmentation information may include the number of used pages in which data is stored and the number of remaining pages in which data is not stored, in a memory block allocated to a zone in a full state. The sum of the number of used pages and the number of remaining pages in each zone may be the same.

In FIG. 9, the zones in the full state may be the second zone, the fifth zone, and the sixth zone, and thus zone fragmentation information of the second, fifth, and sixth zones is illustrated in FIG. 10. However, in an embodiment, the number of used pages and the number of remaining pages of zones not only in the full state but also in the empty state, the open state, or the closed state may also be included in the zone fragmentation information.

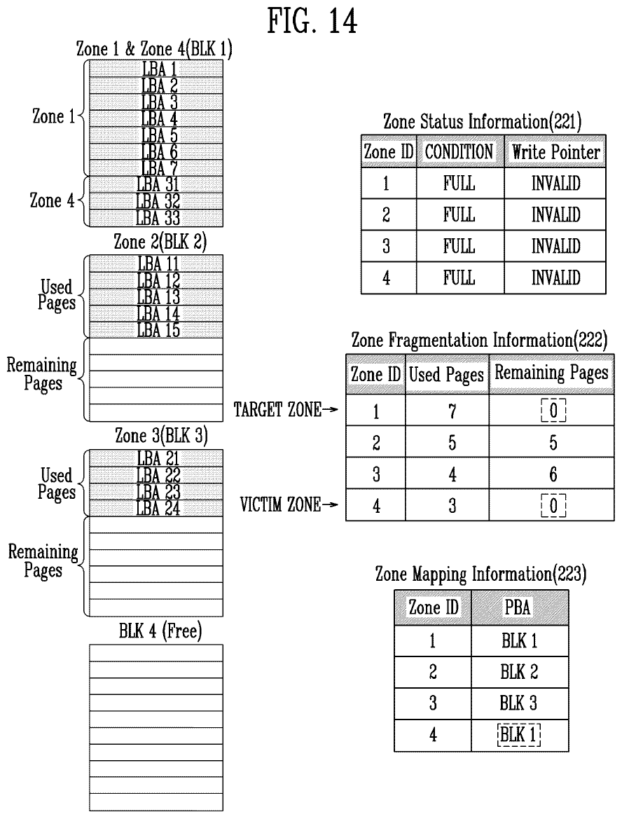

FIG. 11 is a diagram illustrating an example of zone mapping information of FIG. 8.

Referring to FIG. 11, the zone mapping information may include physical addresses of memory blocks in which data corresponding to logical addresses included in respective zones are stored.

For example, physical addresses may be allocated to respective zones so that data in a first zone is stored in an a-th memory block and data in a second zone is stored in a b-th memory block.

In FIG. 11, in some implementations, an example is shown where one memory block is allocated to a single zone by way of example. In other implementations, a plurality of memory blocks may be allocated to a single zone.

FIGS. 12 to 14 are diagrams for explaining an example operation of a data storage device based on some embodiments of the disclosed technology.

In FIG. 12, it is assumed that first to fourth zones Zone 1 to Zone 4 are opened and being used, and each zone is defined as a region including 10 LBAs. That is, the first zone Zone 1 may be a zone that stores data from first to tenth logical addresses LBA 1 to LBA 10, the second zone Zone 2 may be a zone that stores data from eleventh to twentieth logical addresses LBA 11 to LBA 20, the third zone Zone 3 may be a zone that stores data from 21-st to 30-th logical addresses LBA 21 to LBA 30, and the fourth zone Zone 4 may be a zone that stores data from 31-st to 40-th logical addresses LBA 31 to LBA 40.

According to the zone mapping information of FIG. 12, it is assumed that a first memory block is allocated to the first zone and second to fourth memory blocks are allocated to the second to fourth zones.

In FIG. 12, shaded regions indicate logical addresses where data has been stored, and other regions indicate logical addresses where data has not yet been stored.

Data from the first to seventh logical addresses LBA 1 to LBA 7 in the first zone Zone 1 are stored in the first memory block, and the position of a write pointer may indicate the eighth logical address LBA 8.

Data from the eleventh to fifteenth logical addresses LBA 11 to LBA 15 in the second zone Zone 2 are stored in the second memory block, and the position of the write pointer may indicate the 16-th logical address LBA 16.

Data from the 21-st to 24-th logical addresses LBA 21 to LBA 24 in the third zone Zone 3 are stored in the third memory block, and the position of the write pointer may indicate the 25-th logical address LBA 25.

Data at the 31-st to 33-rd logical addresses LBA 31 to LBA 33 in the fourth zone Zone 4 are stored in the fourth memory block, and the position of the write pointer may indicate the 34-th logical address LBA 34.

Because data in some of logical addresses belonging to each of the first to fourth zones Zone 1 to Zone 4 are stored, all of the first to fourth zones Zone 1 to Zone 4 are in the open state.

FIG. 13 is a diagram illustrating zones and zone-related information after a finish zone request for first to fourth zones Zone 1 to Zone 4 is processed.

In FIG. 13, due to the processing of the finish zone request, the states of the first to fourth zones Zone 1 to Zone 4 are changed to a full state, and all of the write pointers of respective zones may indicate invalid values. The operation controller 210, described above with reference to FIG. 8, may update the zone fragmentation information of each of the first to fourth zones Zone 1 to Zone 4 in response to the case where the states of the first to fourth zones Zone 1 to Zone 4 are changed to the full state.

The zone fragmentation information of each of the first to fourth zones Zone 1 to Zone 4 may include used pages in which data is stored and the remaining pages in each zone. In the first zone Zone 1, the number of used pages may be 7, and the number of remaining pages may be 3. In the second zone Zone 2, the number of used pages may be 5, and the number of remaining pages may be 5. In the third zone Zone 3, the number of used pages may be 4, and the number of remaining pages may be 6. In the fourth zone Zone 4, the number of used pages may be 3, and the number of remaining pages may be 7.

The operation controller 210 may select a zone having the smallest number of used pages among the zones in the full state as a victim zone. That is, the fourth zone Zone 4 having the smallest number of used pages may be determined to be the victim zone.

The operation controller 210 may determine, as the target zone, a zone that has a number of remaining pages equal to or greater than the 3 used pages in the fourth zone Zone 4. That is, the first zone Zone 1, which has 3 remaining pages, may be determined as the target zone.

Thereafter, the operation controller 210 may move the data from the used pages of the fourth memory block allocated to the fourth zone Zone 4 corresponding to the victim zone, to the remaining pages of the first memory block allocated to the first zone Zone 1 that is the target zone.

FIG. 14 is a diagram illustrating zones and zone-related information after performance of a zone merge operation of moving the data from the used pages of the fourth memory block allocated to the fourth zone Zone 4 corresponding to the victim zone, to the remaining pages of the first memory block allocated to the first zone Zone 1 that is the target zone.

Referring to FIG. 14, data from 31-st to 33-rd logical addresses LBA 31 to LBA 33 in the fourth memory block allocated to the fourth zone Zone 4 corresponding to the victim zone, are moved to the first memory block allocated to the first zone Zone 1. Accordingly, the same memory block, that is, the first memory block, may be allocated to the first zone Zone 1 and the fourth zone Zone 4.

The operation controller 210 may store the data present in the victim zone in the target zone, and thereafter update the zone fragmentation information 222 and the zone mapping information 223.

FIGS. 15 and 16 are diagrams for explaining an example operation of a data storage device based on some embodiments of the disclosed technology.

In FIG. 15, first memory blocks allocated to a zoned region and second memory blocks allocated to a non-zone-based region are illustrated. Because data stored in first to fourth zones Zone 1 to Zone 4 and zone states thereof are identical to those in the embodiment of FIG. 13, detailed description thereof will be omitted.

The second memory blocks allocated to the non-zone-based region may be fifth to eighth blocks BLK 5 to BLK 8.

Data stored in the fifth to eighth blocks BLK 5 to BLK 8 may be divided into valid data and invalid data. The data storage device may perform a garbage collection operation in a case that the number of free blocks, which are empty memory blocks with no data, falls below a certain threshold (e.g., a predetermined number of free blocks).

The garbage collection operation may be a background operation performed to secure free blocks when the number of free blocks in the memory device 100 is less than the certain threshold.

The operation controller 210 may determine a fifth memory block BLK5 in which the least amount of valid data is stored among the second memory blocks to be a victim block. The operation controller 210 may determine the second block BLK2, allocated to the second zone Zone 2 that is a zone including a number of remaining pages equal to or greater than the 5 valid pages included in the fifth block BLK5, which is the victim block, to be the target block based on the zone fragmentation information 222. The operation controller 210 may control the memory device 100 to store or move the valid data from the fifth block BLK5, which is the victim block, into the remaining pages of the second block BLK2, which is the target block.

FIG. 16 illustrates the states of first memory blocks and second memory blocks after a garbage collection operation is performed.

The fifth block BLK5 that is a victim block may be a free block after an erase operation is performed.

Because valid data in the fifth block BLK5 is stored in the remaining pages of the second zone Zone 2, no more remaining pages are present in the second zone. Therefore, the operation controller 210 may update the zone fragmentation information 222 of the zone to which the target block is allocated after the garbage collection operation is performed.

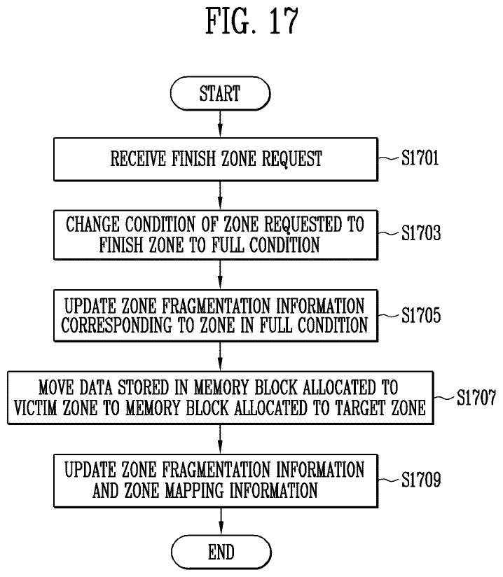

FIG. 17 is a flowchart illustrating an example operation of a data storage device based on some embodiments of the disclosed technology.

Referring to FIG. 17, at step S1701, the data storage device may receive a finish zone request from a host. The finish zone request may be a request provided by the host to the data storage device when additional data storage is not performed on the zone.

At step S1703, the data storage device may change the state of the zone requested to finish the zone to a full state. As the state of the zone has changed to the full state, the write pointer of the zone may be changed to an invalid value.

At step S1705, the data storage device may update the zone fragmentation information of the zone, the state of which has changed to the full state. For example, the data storage device may include a zone information storage in which the zone fragmentation information of zones in the full state is stored. The zone fragmentation information may include the number of used pages and the number of remaining pages included in a memory block allocated to the zone in the full state.

At step S1707, the data storage device may move data stored in the memory block allocated to the victim zone to the memory block allocated to the target zone. In detail, the data storage device may determine a zone having the smallest number of used pages to be the victim zone based on the zone fragmentation information. Thereafter, the data storage device may determine a zone, having a number of remaining pages equal to or greater than the number of used pages included in the memory block allocated to the victim zone, to be the target zone. The data storage device may move the data, stored in the used pages of the memory block allocated to the victim zone, to the remaining pages of the memory block allocated to the target zone.

At step S1709, the data storage device may update the zone fragment information of the victim zone and the target zone, and may update the zone mapping information of the victim block.

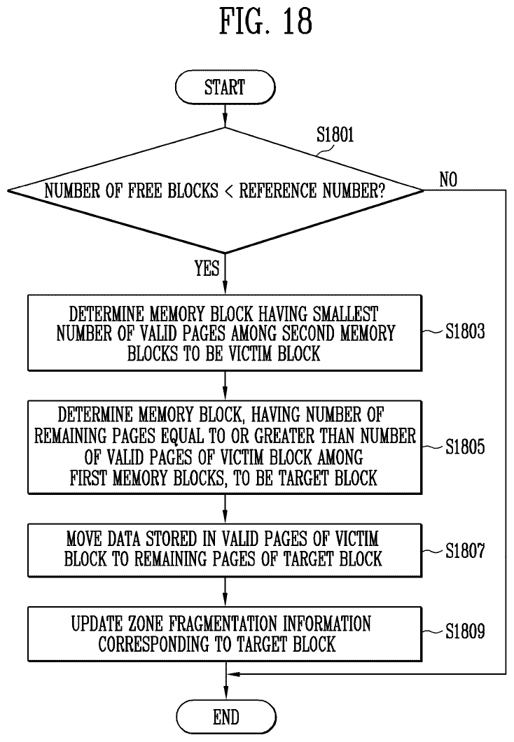

FIG. 18 is a flowchart illustrating an example operation of a data storage device based on some embodiments of the disclosed technology.

Referring to FIG. 18, at step S1801, the data storage device may determine whether the number of free blocks included in the memory device is less than the preset reference number of free blocks. When it is determined that the number of free blocks is less than the preset reference number, a garbage collection operation described at steps S1803 to S1809 may be performed. When it is determined that the number of free blocks is not less than the preset reference number, the garbage collection operation may not be performed.

At step S1803, the data storage device may determine a memory block in which the number of valid pages that are pages in which valid data is stored is the smallest, among the second memory blocks, to be a victim block.

At step S1805, the data storage device may determine a zone, which includes a number of remaining pages equal to or greater than the number of valid pages included in the victim block, to be a target zone, and may determine a memory block allocated to the target zone among the first memory blocks to be a target block.

At step S1807, the data storage device may move the data (valid data) stored in the valid pages included in the victim block to the remaining pages of the target block.

At step S1809, the data storage device may update the zone fragmentation information corresponding to the target block.

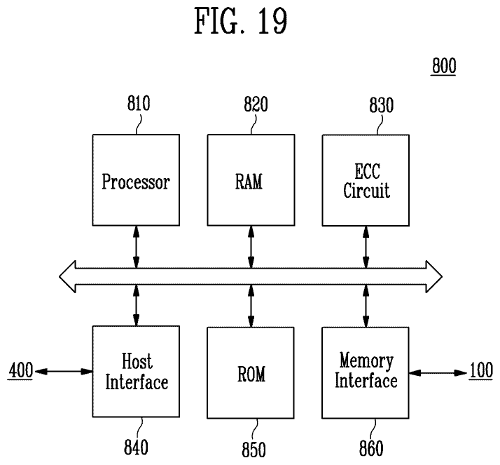

FIG. 19 is a diagram illustrating an example of the controller of FIG. 1.

Referring to FIG. 19, a memory controller 800 may include a processor 810, a random access memory (RAM) 820, an error correction circuit 830, a host interface 840, a read only memory (ROM) 850, and a memory interface 860. The memory controller 800 may be the controller 200, described above with reference to FIG. 1.

The processor 810 may control the overall operation of the memory controller 800. The RAM 820 may be used as a buffer memory, a cache memory or a working memory of the memory controller 800. The operation controller 210, described above with reference to FIG. 8, may be stored in the ROM 850 or the RAM 820 in the form of software executed by the processor 810. Further, the zone information storage 220 may be included in the RAM 820.

In an embodiment, the ROM 850 may store various types of information required for operating the memory controller 800 in the form of firmware.

The memory controller 800 may communicate with an external device (e.g., the host 400, an application processor or the like) through the host interface 840.

The memory controller 800 may communicate with the memory device 100 through the memory interface 860. The memory controller 800 may transmit a command CMD, an address ADDR, a control signal CTRL, or the like to the memory device 100 and transmit and receive data DATA to and from the memory device 100, through the memory interface 860.

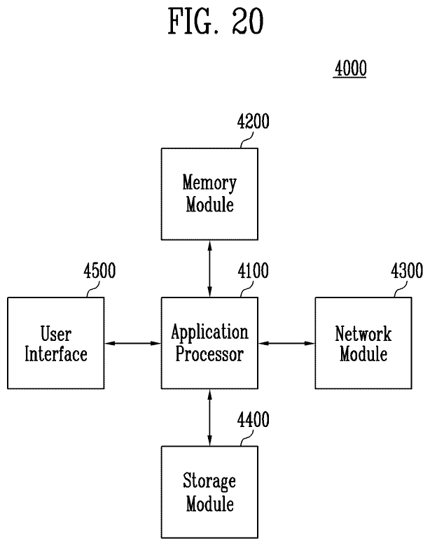

FIG. 20 is a block diagram illustrating a user system based on some embodiments of the disclosed technology.

Referring to FIG. 20, a user system 4000 may include an application processor 4100, a memory module 4200, a network module 4300, a storage module 4400, and a user interface 4500.

The application processor 4100 may run components included in the user system 4000, an operating system (OS) or a user program. In an embodiment, the application processor 4100 may include controllers, interfaces, graphic engines, etc. for controlling the components included in the user system 4000. The application processor 4100 may be provided as a system-on-chip (SoC).

The memory module 4200 may function as a main memory, a working memory, a buffer memory or a cache memory of the user system 4000. The memory module 4200 may include volatile RAMs such as DRAM, SDRAM, DDR SDRAM, DDR2 SDRAM, DDR3 SDRAM, LPDDR SDRAM, LPDDR2 SDRAM, and LPDDR3 SDRAM or nonvolatile RAMs such as PCM, ReRAM, MRAM, and FRAM. In an embodiment, the application processor 4100 and the memory module 4200 may be packaged based on a package-on-package (POP), and may then be provided as a single semiconductor package.

The network module 4300 may communicate with external devices. In an embodiment, the network module 4300 may support wireless communication, such as code division multiple access (CDMA), a global system for mobile communication (GSM), wideband CDMA (WCDMA), CDMA-2000, time division multiple access (TDMA), long term evolution (LTE), Wimax, WLAN, UWB, Bluetooth, or Wi-Fi. In an embodiment, the network module 4300 may be included in the application processor 4100.

The storage module 4400 may store data. For example, the storage module 4400 may store data received from the application processor 4100. Alternatively, the storage module 4400 may transmit the data stored in the storage module 4400 to the application processor 4100. In an embodiment, the storage module 4400 may be implemented as a nonvolatile semiconductor memory device, such as a phase-change RAM (PRAM), a magnetic RAM (MRAM), a resistive RAM (RRAM), a NAND flash memory, a NOR flash memory, or a NAND flash memory having a three-dimensional (3D) structure. In an embodiment, the storage module 4400 may be the data storage device 50, described above with reference to FIG. 1. Alternatively, in various embodiments, the storage module 4400 may be provided as a removable storage medium (removable drive), such as a memory card or an external drive of the user system 4000.

In an embodiment, the storage module 4400 may include a plurality of nonvolatile memory devices, each of which may be operated in the same manner as the memory device 100, described above with reference to FIG. 1. The storage module 4400 may be operated in the same manner as the data storage device 50, described above with reference to FIG. 1.

The user interface 4500 may include interfaces which input data or instructions to the application processor 4100 or output data to external devices. In an embodiment, the user interface 4500 may include user input interfaces such as a keyboard, a keypad, a button, a touch panel, a touch screen, a touch pad, a touch ball, a camera, a microphone, a gyroscope sensor, a vibration sensor, and a piezoelectric element. The user interface 4500 may include user output interfaces such as a liquid crystal display (LCD), an organic light emitting diode (OLED) display device, an active matrix OLED (AMOLED) display device, an LED, a speaker, and a monitor.

In this way, data storage devices and methods of operating the data storage devices implemented based on some embodiments of the disclosed technology can efficiently manage storage space.

The embodiments and implementations disclosed above are examples only, and thus various enhancements and variations to the disclosed embodiments and implementations and other embodiments and implementations can be made based on what is described and illustrated in this patent document.

What is claimed is:

1. A data storage device, comprising:
a memory device including a plurality of memory blocks allocated to a plurality of zones that are storage regions corresponding to a plurality of logical address groups provided from a host; and
a controller configured to control the memory device to select a victim zone for moving stored data to a target zone, from among zones for which a finish zone request is received from the host, and move data from a memory block allocated to the victim zone to a remaining space of a memory block allocated to the target zone, wherein the finish zone request is received from the host.

2. The data storage device according to claim 1, wherein the controller comprises:
a zone information storage configured to store zone status information that includes information about respective states of the plurality of zones and respective write pointers of the plurality of zones to indicate locations where data is to be written; and
an operation controller configured to receive a write request and write data corresponding to the write request from the host, and configured to, upon storing the write data in a memory block allocated to a zone corresponding to the write request among the plurality of zones, update the zone status information to change the write pointer of the zone corresponding to the write request to a next logical address of a logical address for the write data in a logical address group of the zone corresponding to the write request among the plurality of logical address groups.

3. The data storage device according to claim 2, wherein:
each of the plurality of logical address groups includes logical addresses having a preset range, and
the operation controller is configured to update the zone status information to modify the write pointer to point to a logical address at which the write data is to be stored, among the logical addresses having the preset range.

4. The data storage device according to claim 2, wherein the controller is configured to set each of the plurality of zones to one of:
a full state indicating the write pointer has an invalid value;
an open state indicating the write pointer points to a logical address having a value other than a lowest value among the logical addresses having a preset range;
an empty state indicating the write pointer points to a logical address having the lowest value among the logical addresses having the preset range; or
a read only state indicating only read operations are allowed for data stored in the zone.

5. The data storage device according to claim 4, wherein the operation controller is configured to change states of the zones, for which the finish zone request is received among the plurality of zones, to the full state and update the zone status information.

6. The data storage device according to claim 5, wherein the zone information storage includes zone fragmentation information about a remaining storage space of the memory blocks allocated to the plurality of zones.

7. The data storage device according to claim 6, wherein the zone fragmentation information includes information about a number of remaining pages, among pages included in the memory blocks allocated to the plurality of zones, that do not have data stored.

8. The data storage device according to claim 7, wherein the operation controller is configured to select, among the plurality of zones a zone in the full state with a largest number of remaining pages as the victim zone.

9. The data storage device according to claim 8, wherein the operation controller is configured to determine, as the target zone, a zone, among the zones in the full, that includes a number of remaining pages equal to or greater than a number of pages with data included in the memory block allocated to the victim zone.

10. The data storage device according to claim 9, wherein the zone information storage includes zone mapping information regarding physical addresses of the memory blocks allocated to the plurality of zones.

11. The data storage device according to claim 10, wherein the operation controller is configured to: store data from the victim zone into the memory block allocated to the target zone; and remove, from the zone mapping information, a physical address of the memory block allocated to the victim zone.

12. The data storage device according to claim 10, wherein the operation controller is configured to, upon receiving, from the host, a reset write pointer request for the victim zone and the target zone, remove, from the zone mapping information, a physical address of the memory block allocated to the target zone.

13. A data storage device, comprising:
a memory device including a plurality of first memory blocks allocated to a plurality of zones, and a plurality of second memory blocks that are remaining memory blocks other than the first memory blocks; and
a controller configured to control the memory device to perform a garbage collection operation by: storing data from a victim memory block that is selected according to a size of stored valid data from among the second memory blocks, into a remaining storage space of a target memory block selected from among the first memory blocks.

14. The data storage device according to claim 13, wherein the controller comprises:
an operation controller configured to, upon determination that a number of free blocks corresponding to available memory blocks included in the memory device is less than a preset reference number of free blocks, perform the garbage collection operation.

15. The data storage device according to claim 14, wherein the controller further comprises:
a zone information storage including zone fragmentation information regarding a remaining storage space of the first memory blocks.

16. The data storage device according to claim 15, wherein the operation controller is configured to control the memory device to store valid data from a victim block corresponding to a memory block with a smallest number of valid pages in which valid data is stored among the second memory blocks, into a remaining page of a target block determined based on the zone fragmentation information among the first memory blocks.

17. The data storage device according to claim 16, wherein the operation controller is configured to, after the valid data in the victim block is stored in the target block, update the zone fragmentation information corresponding to the target block.

18. The data storage device according to claim 15, wherein the zone information storage stores zone status information regarding respective states of the plurality of zones and respective write pointers of the plurality of zones.

19. The data storage device according to claim 18, wherein:
the operation controller is configured to set each of the plurality of zones to one of: a full state indicating the write pointer has an invalid value; an open state indicating the write pointer points to a logical address having a value other than a lowest value among the logical addresses having a preset range; an empty state indicating the write pointer points to a logical address having the lowest value among the logical addresses having the preset range; or a read only state indicating only read operations are allowed for data stored in the zone, and
the zone fragmentation information includes information regarding a remaining storage space of the first memory blocks allocated to zones in the full state among the plurality of zones.

20. A data storage device, comprising:
a memory device including memory blocks; and
a controller configured to allocate the memory blocks to a plurality of zones, respectively, and control the memory device to move data from memory blocks respectively allocated to two or more zones in a full state in which a write pointer has an invalid value among the plurality of zones, to a memory block allocated to one zone selected from among the two or more zones in response to a finish zone request received from a host.
